(19) United States
(12) Patent Application Publication
(10) Pub. No.: US 2009/0168166 A1
(43) Pub. Date: Jul. 2, 2009

(54) Stereoscopic Optical System And Method For Production Of A Stereoscopic Optical System

(75) Inventor: Andreas Obrebski, Düsseldorf (DE)

Correspondence Address: JONES DAY, 222 EAST 41ST ST, NEW YORK, NY, 10017, US

(73) Assignee: CARL ZEISS SURGICAL GMBH, OBERKOCHEN (DE)

(21) Appl. No.: 11/988,024

(22) PCT Filed: Jun. 28, 2006
(86) PCT No.: PCT/EP2006/006254

§ 371 Date: Dec. 28, 2007

(30) Foreign Application Priority Data
Jun. 29, 2005 (DE) 10 2005 030 346.3

(51) Int. Cl. G02B 27/22; B21D 39/00; G02B 21/22

(52) U.S. Cl. 359/466; 29/428; 359/377

(57) ABSTRACT

The invention relates to a stereoscopic optical system (1), comprising a first optical sub-system (2L) with a number of optical elements (31L, 32L, 33L, 34L, 35L, 36L, 37L, 38L, 39L) for providing a left beam path (4L) of the stereoscopic optical system (1), and a second optical sub-system (2R) with a number of optical elements (31R, 32R, 33R, 34R, 35R, 36R, 37R, 38R, 39R) for providing a right beam path (4R) of the stereoscopic optical system (1). At least one first optical partial element (38L) of the first optical sub-system (2L) has a first optical surface (O1), and at least one second optical partial element (38R) of the second optical sub-system (2R) has a second optical surface (O2). According to the invention, the first and the second optical surfaces (O1, O2) are partial surfaces of one common mathematical surface that is rotationally symmetrical about a common main axis (7) of the stereoscopic optical system (1). The invention further relates to a method for production of such a stereoscopic optical system.

The present invention relates to a stereoscopic optical system and a method for manufacturing a stereoscopic optical system.

A stereoscopic optical system typically exhibits a first optical sub-system with a plurality of optical elements for providing a left/first beam path and a second optical sub-system with a plurality of optical elements for providing a right/second beam path.

It is typical for stereoscopic optical systems that the beam bundles guided by the two beam paths intersect with each other forming a stereoscopic-angle α in a focusing point outside of the stereoscopic optical system.

Since the two beam paths are typically associated with the left and right eyes, respectively, of a user the two beam paths are often also called left and right beam path.

Instead of the eye of a user the two beam paths can for example also be supplied to a first or second, photosensitive spatially resolving semiconductor element. The first and second semiconductor element may for example be a first and a second CCD chip. In this case the two beam paths are usually denoted as a first and a second beam path, respectively. Such stereoscopic optical systems are for example used as a stereoscopic-camera.

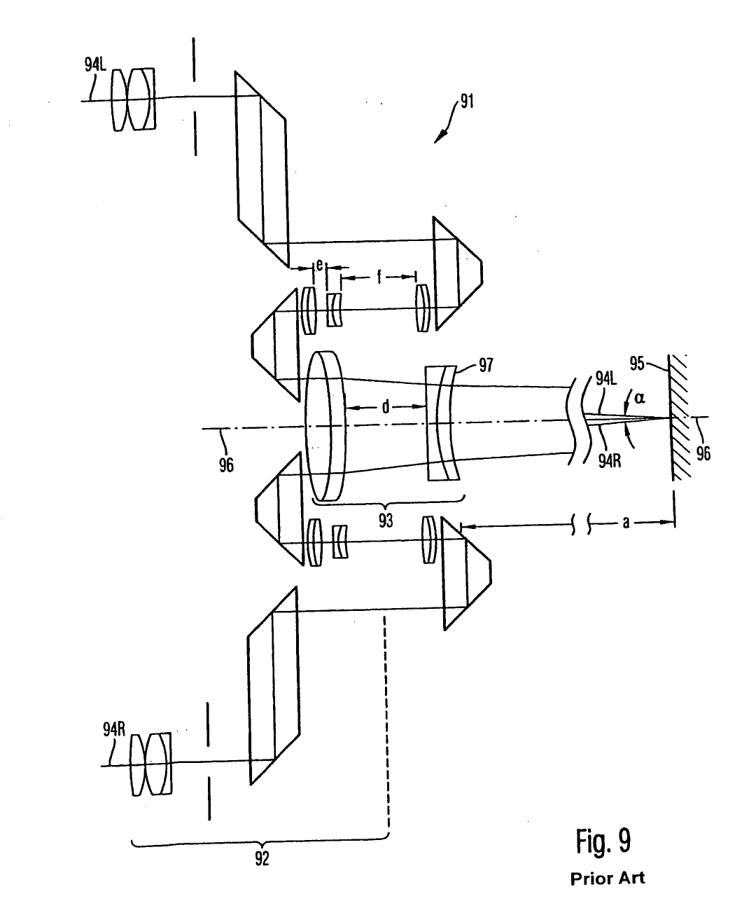

A beam path of a stereoscopic optical system known from the German patent application DE 101 34 896 A1 is illustrated in FIG. 9.

The stereoscopic optical system 91 according to the prior art exhibits two ocular systems 92 and a common objective system 93. In FIG. 9 central beams of the partial beam bundles guided in the beam paths 94L and 94R are illustrated. The central beams guided by the beam paths 94L and 94R are imaged by the objective system 93 such that they meet at an object 95 to be observed and such that they intersect with each other forming a stereoscopic-angle α.

For the central beams of the beam paths 94L and 94R, the optical system 91 is symmetrically constructed with respect to a common central axis 96 of the optical system 91. The central beams emanating from the object 95 enter the objective system 93 of the stereoscopic optical system 91 via a common optical principal entry lens 97. Thus, the objective system 93 is provided in common for the two central beams of the two beam paths 94L and 94R.

Thereby, the two central beams are guided in the common objective system 93 such that they do not overlap but traverse the common objective system 93 in different regions of the used optical lenses 97.

After leaving the common objective system 93, each of the central beams enters an ocular system 92, wherein a particular ocular system 92 is associated with each of the two beam paths 94L and 94R and thus to each central beam.

By varying lens distances e, f and d respectively, in the stereoscopic optical system 91, it is possible to provide a variable magnification (zoom function) of the observed object 95, respectively to vary the working distance (focusing) for adjustment to an observed object 95. Thereby the utilization of a common objective system 93 for the two central beams of the two beam paths 94L and 94R ensures that the two central beams meet in the object plane even after varying a distance (focusing) by adapting the distance d and that they thereby always intersect forming a stereoscopic-angle α. This is achieved by appropriate choice of the optical surfaces of the optical lenses of the common objective system 93.

The content of the German patent application DE 101 34 896 A1, which is incorporated by reference in its entirety, is part of the disclosure of the present patent application.

In the stereoscopic system described above, it is disadvantageous that the common objective system is very heavy. The reason for this is that the two central beams must be guided in the common objective system such that they traverse the optical lenses of the common objective system at least partially in different regions. Further, the optical lenses of the objective system are required to allow a certain displacement, magnification and/or diminution of the region of traversal of the two central beams. As a consequence, the optical lenses of the common objective system that are commonly used by the two central beams must be designed in very large dimensions.

During usage of such a stereoscopic system as a head-mountable loupe, for example, the heavy weight of the objective system results in a significant impairment of the mobility of the user. Moreover, the heavy weight often leads to a premature exhaustion of the user and to a cramping of the neck muscles.

From patent document DE 21 59 093 a stereoscopic-microscope is known in which a left and a right imaging beam paths are guided entirely separately. Thereby in each of the two imaging beam paths an objective lens is used which was rendered eccentric by removing a peripheral section. Further, an area of the removed section of the respective lens is significantly smaller than the remaining area of the corresponding lens. The two objective lenses are arranged in the objective of the stereoscopic-microscope towards the object, the removed sections facing each other.

In the construction already known from DE 21 59 093 it is disadvantageous that firstly, for manufacturing the two eccentric lenses, two correspondingly larger lenses must be provided. These two larger lenses must—as for a Greenough system—be manufactured with high accuracy. As a consequence, the known system has high manufacturing costs. Furthermore, for the known stereoscopic-microscope, it is difficult to arrange the two eccentric objective lenses with sufficient accuracy relative to each other.

According to an embodiment, it is an object of the present invention to provide a stereoscopic optical system which exhibits an objective system with low weight and which can be manufactured with sufficient accuracy in a simple and economic way.

According to a further embodiment, it is an object of the present invention to provide a method that enables manufacturing a stereoscopic optical system exhibiting an objective system with low weight by simple means in an economic way with the required accuracy.

According to two alternative embodiments, the preceding object is solved by a stereoscopic optical system with the features of one of independent claims 1 or 6. Further, the preceding object is solved according to two alternative embodiments by a method with the combination of the features of one of independent claims 15 and 25. Advantageous embodiments are found in the respective dependent claims.

According to an embodiment, a stereoscopic optical system comprises a first optical sub-system with a plurality of optical elements for providing a left beam path of the stereoscopic optical system and a second optical sub-system with a plurality of optical elements for providing a right beam path of the stereoscopic optical system. Thereby at least one optical partial element of the first optical sub-system exhibits a first optical surface and at least one second optical partial element of the second optical sub-system exhibits a second optical surface. Further, the first and the second optical surfaces are partial surfaces of a common mathematical surface, which is rotationally symmetric about a common principal axis of the stereoscopic optical system.

Since the two optical surfaces of the two optical partial elements are partial surfaces of a mathematical surface that is rotationally symmetric about a common principal axis of the stereoscopic optical system, the two optical partial elements function as one optical element of the stereoscopic optical system, common for the left and the right beam paths. Nevertheless, it is not required to use common optical elements for the left and the right beam paths in this embodiment. This increases the flexibility of the arrangement and enables a constructive separation of the two beam paths, for example. However, for a constructive separation of the two beam paths it is required that the two beam paths do not overlap in the region of the optical partial elements.

Moreover, the preceding choice of the first and second optical surfaces of the first and second optical partial element of the left and right beam path of the stereoscopic optical system enables the formation of two optical partial elements by separating from one single optical element that defines the common mathematical surface before the separating. Thus, it is merely required to manufacture one rotationally symmetric optical element having an optical surface defining the common mathematical surface with high accuracy. Subsequently, the two optical partial elements may be formed by sawing or cutting from such an optical element, for example. Thereby it is ensured that the two optical surfaces of the two optical partial elements exhibit the same accuracy. Consequently, the objective system of the preceding stereoscopic optical system can be manufactured in a particularly simple and thus economic way.

Further, according to an embodiment, the first and the second optical surfaces of the two optical partial elements exhibit in the sum a surface, which is smaller than the common mathematical surface. Due to saving of material of the first and second optical partial elements compared to the usage of one common optical element for the left and the right beam paths, this causes a diminishment of the construction of the stereoscopic optical system and a reduction of the weight of the stereoscopic optical system.

According to an embodiment, a third optical partial element of the first optical sub-system exhibits a third optical surface, and a fourth optical partial element of the second optical sub-system exhibits a fourth optical surface. Thereby, the third and the fourth optical surfaces are partial surfaces of one common mathematical surface that is rotationally symmetric about the principal axis of the stereoscopic optical system. Further, the first optical partial element and the third optical partial element are separated from each other along the principal axis of the stereoscopic optical system by a distance.

In this case it may be advantageous, according to an embodiment, that the stereoscopic optical system further comprises an actuator, to vary the distance between the first optical partial element and the third optical partial element along the principal axis of the stereoscopic optical system.

As already set forth, the first and the second optical surfaces of the first and second optical partial element, and the third and fourth optical surfaces of the third and fourth optical partial element are pairwise partial surfaces of one common mathematical surface that is rotationally symmetric about the common principal axis of the stereoscopic optical system. Therefore, a variation of the distance of the first optical partial element from the third optical partial element along the principal axis of the stereoscopic optical system also automatically involves a variation of the distance of the second optical partial element from the fourth optical partial element along the principal axis of the stereoscopic optical system.

According to an embodiment the first optical partial element and the third optical partial element of the stereoscopic optical system are arranged in a common beam path of the stereoscopic optical system.

Such a construction enables a changing of the working distance (focusing) for adjustment to an observed object without the need to utilize common optical elements for the left and the right beam paths. The changing of the working distance is performed by a variation of the distance of the first and the second optical partial elements from the third and fourth optical partial elements along the principal axis of the stereoscopic optical system. With an appropriate selection of the common mathematical surface for the first and second optical partial elements, and for the third and fourth optical partial elements, the preceding construction ensures that central beams of the left and the right beam paths automatically always intersect forming a stereoscopic angle α in an object plane of the stereoscopic optical system, even after changing of working distance and thus after changing the distance between the optical partial elements.

In the simplest case, the first and the second optical partial elements and, if applicable, also the third and fourth optical partial elements, are each an optical lens. Alternatively, the first and second and/or third and fourth optical partial elements may for example also be an optical mirror.

According to a further embodiment, a stereoscopic optical system for displaying a stereoscopic image of an object via a left beam path and a right beam path is provided.

Thereby, the stereoscopic optical system according to this further embodiment comprises a principal optics commonly traversed by the left beam path and the right beam path with (at least) one first optical element having an optical principal axis, a left optical sub-system merely traversed from the left beam path with a plurality of optical elements, and a right optical sub-system merely traversed from the right beam path with a plurality of optical elements. Thereby, a refraction force of at least one optical element and/or a refraction force of an optical group formed by plural optical elements is variable, in a way that cross sections of an bundle of imaging beams of the left beam path and of an bundle of imaging beams of the right beam path vary in dependence of the variation of the refraction force.

Thereby, a total area of an optical surface of the first optical element of the principal optics furthermore exhibits a value, which is smaller than 1.8 times a maximum value of an area covered by the cross sections of the bundles of imaging beams on the optical surface of the first optical element of the principal optics.

Consequently, with the preceding stereoscopic optical system, it is ensured that the at least one first optical element of the principal optics exhibits a structural shape that is adapted with respect to the maximal cross sections of the bundles of imaging beams on the optical surface of the respective first optical element. Thereby, the provision of a first optical element with the smallest structural shape and thus also minimal weight is possible.

At the same time the preceding stereoscopic optical system ensures that the total area of the optical surface of the first optical element is sufficient to accommodate substantial parts of the bundles of imaging beams and to allow mounting of the first optical element.

According to an embodiment the at least one optical element is an optical element of variable refraction force, wherein the refraction force of the at least one optical element is variable by controlling the optical element.

Lenses with variable and thus adjustable and changeable refraction force are known from the prior art, for example from U.S. Pat. No. 4,795,248 or U.S. Pat. No. 5,815,233. Such lenses with adjustable refraction force comprise a liquid crystal layer controllable via an electrode structure, to adjust an optical path length provided by the liquid crystal layer for a beam traversing the layer to desired values. This is performed in dependency of a location, in other words across the cross section of the lens, whereby a flexible lens effect is achieved.

Alternatively, such an optical element with variable refraction force may for example also be a fluid lens. A fluid lens typically comprises a housing with two entry and exit windows between which two liquids with different refractive forces are enclosed, that preferably are essentially not mixable with each other. The housing provides a conical wall that is symmetrical with respect to an optical axis of the liquid lens for the two liquids. The conical walls are contacted by a boundary layer between the two liquids forming a contact angle. One liquid is electrically conductive while the other liquid is essentially electrically non-conductive. The angle that the boundary layer between the two liquids includes with the wall can be changed by applying a voltage. Due to the different refractive forces of the two liquids a lens effect of the lens for a light beam traversing the lens along the optical axis is changeable.

A liquid lens may for example be purchased from the company Varioptic, 69007 Lyon, France.

Further liquid lenses utilizing a changing of a shape of a boundary layer for changing their refraction force are known from U.S. Pat. No. 6,369,954 B1, CA 2,368,553 and U.S. Pat. No. 4,783,155, the disclosures of which are entirely incorporated in the present application by reference.

According to an embodiment, the optical group is formed by at least one optical element of the principal optics and at least one optical element of the left and the right optical sub-systems, and the at least one optical element of the principal optics and/or the at least one optical element of the left and the right optical sub-systems are displaceable relative to each other for changing the refraction force of the group.

Such displaceability is usually provided for realizing a zoom function and/or a focusing function. Thereby, the zoom function and/or the focusing function may optionally be realized by the main optics and/or the left and right optical sub-system. Also a combined realization by the principal system and the left, respectively, right optical sub-system is possible.

According to an embodiment, the total area of one optical surface of the first optical element of the principal optics exhibits a value which is smaller than 1.5 times, preferably smaller than 1.3 times, a maximal value of the area covered by the cross sections of the bundles of imaging beams on the optical surface of the first optical element of the principal optics. According to an embodiment, the total area of one optical surface of the first optical element of the principal optics exhibits a value which is smaller than 1.2 times, and in particular smaller than 1.1 times, a maximal value of the area covered by the cross sections of the bundles of imaging beams on the optical surface of the first optical element of the principal optics.

According to an embodiment, the principal optics exhibits at least one second optical element arranged in a way that the first and the second optical elements have one common optical principal axis. Thereby, the first optical element and the second optical element are separated from each other along the common optical principal axis by a distance.

To allow a change of a working distance (focusing) for adjusting the stereoscopic optical system to an observed object, according to an embodiment the stereoscopic optical system may further comprise an actuator, to change the relative distance of the first optical element from the second optical element along the optical principal axis. Thereby, the construction described above ensures that the left and the right beam paths automatically always intersect forming a stereoscopic angle α in an object plane of the stereoscopic optical system also after changing of the working distance, and thus after changing of the relative distance of the first optical element from the second optical element, provided an appropriate choice of optical surfaces of the first and the second optical elements has been made.

According to an embodiment, each of the first and the second optical elements is an optical lens. Alternatively, the first and/or the second optical elements may be optical mirrors, for example.

According to an embodiment, the stereoscopic optical system is a head-mountable loupe fixable to a head of a user, since here the saving of weight associated with the preceding construction is especially beneficial.

According to an alternative embodiment, the stereoscopic optical system may for example be a stereoscopic microscope, in particular a surgery microscope.

According to an embodiment, a method for manufacturing a stereoscopic optical system comprises the following steps: manufacturing at least one first optical element exhibiting at least one optical surface rotationally symmetric about an axis; dividing the first optical element into at least one first optical partial element and one second optical partial element, in a way that the first and the second optical partial elements exhibit parts of the at least one optical surface of the first optical element; and mounting the first optical partial element and the second optical partial element in a frame system, in a way that the optical surface of the first optical partial element and the optical surface of the second optical partial element are arranged rotationally symmetrically about a common optical axis.

The above method of manufacturing the first and second optical partial elements by separating from one single first optical element ensures that both optical surfaces of both optical partial elements exhibit the same accuracy and property as the optical surface of the first optical element. Thus, it is merely required to manufacture the optical surface of the first optical element, which optical surface is rotationally symmetric about an axis, with the desired accuracy.

The preceding arrangement of the first and second optical partial elements at the frame system thereby ensures that the optical surfaces of the first and the second optical partial elements act, with respect to the common optical axis, as the optical surface of one common optical element.

As a consequence, the preceding method enables manufacturing the stereoscopic optical system more simply, in a cost effective way and with the required accuracy.

According to an embodiment, a sum of the areas of the optical surface of the first optical partial element and of the optical surface of the second optical partial element is smaller than the optical surface of the first optical element before the dividing.

This results in a diminishing of the construction form of the stereoscopic optical system and a lowering of the weight of the stereoscopic optical system. Furthermore, several pairs of first and second optical partial elements can thus be formed from the first optical element, if applicable.

According to an embodiment, the frame system exhibits a first frame component and a second frame component, and the method further comprises fixing the first optical element to the first frame component before the step of dividing. According to an embodiment the mounting the first optical partial element and the second optical partial element to the frame system after the step of dividing then comprises attaching the first frame component to the second frame component, wherein the first and the second optical partial elements remain fixed to the first frame component.

Since the first and the second optical partial elements remain fixed to the first frame component, even after the step of dividing the first optical element, it is ensured by appropriate choice of the at least one dividing line, that the optical surface of the first optical partial element and the optical surface of the second optical partial element are automatically arranged rotationally symmetrically about a common optical axis after the step of dividing. The step of assembling the first frame component above the second frame component in the stereoscopic optical system considerably simplifies the step of mounting the first optical partial element and the second optical partial element to the frame system. At the same time, the accuracy of the relative arrangement of the first and second optical partial elements to each other is increased in a particularly simple way.

According to a modified embodiment, the frame system also exhibits a first frame component and a second frame component. Thereby, the method comprises a step of fixing the first optical element to an auxiliary frame before the step of dividing. Further, the method comprises a step of fixing the first optical partial element and the second optical partial element to the first frame component after the step of dividing, wherein the first optical partial element and the second optical partial element remain fixed to the auxiliary frame. After the step of fixing the first optical partial element and the second optical partial element to the first frame component, a step of detaching the first optical partial element and the second optical partial element from the auxiliary frame is performed. The step of mounting the first optical partial element and the second optical partial element to the frame system after the step of dividing comprises a step of attaching the first frame component to the second frame component, wherein the first and the second optical partial elements remain fixed to the first frame component.

The usage of an auxiliary frame to which the first optical element is fixed before the step of dividing ensures that relative position and orientation of the optical partial elements formed by the step of dividing relative to each other is also maintained after the dividing. At the same time, the auxiliary frame may be chosen in a way that a fragmenting the first optical element in a plurality of pairs of optical partial elements, for example by using a saw, is easily feasible. Since the optical partial elements are detached from the auxiliary frame only after the step of fixing to the first frame component, it is moreover ensured that the relative position and orientation of the optical partial elements to each other is also maintained after the step of moving. Moreover, assembling the first frame component above the second frame component in the stereoscopic optical system considerably simplifies the step of mounting the first optical partial element and the second optical partial element to the frame system while ensuring a high accuracy.

Since the first frame component does not have to hold the entire first optical element and also does not have to enable a dividing the first optical element, due to the usage of an auxiliary frame, the first frame component moreover may exhibit a particularly compact structural shape.

To manufacture a plurality of stereoscopic optical systems, according to an embodiment it can be envisaged, that the step of dividing the first optical element comprises dividing into a plurality of pairs of optical partial elements and that the step of mounting comprises respective mounting of each pair of optical partial elements to a separate frame system.

Thus, from a single first optical element a plurality of pairs of optical partial elements for a plurality of stereoscopic optical systems can be formed. Thereby, the manufacturing costs for the stereoscopic optical systems can be considerably reduced.

In this case, according to an embodiment it can be envisaged that each of the plurality of frame systems comprises a first frame component. Further, according to an embodiment, the method moreover comprises a step of fixing the first frame component of each of the plurality of frame systems to the first optical element before the step of dividing. Then, subsequently, the method comprises separating the first frame components of the plurality of frame systems from each other, wherein on each of the first frame components a respective pair of optical partial elements remains fixed.

Since, a respective pair of the optical partial elements remains fixed on each of the first frame components after the step of dividing, it is ensured with high accuracy that the optical surfaces of the pairs of the optical partial elements are automatically arranged rotationally symmetrically about a common optical axis after the step of dividing, by appropriate choice of the dividing lines.

According to an embodiment, the method further comprises manufacturing a second optical element exhibiting at least one optical surface rotationally symmetric about an axis. Moreover, the method comprises dividing the second optical element into at least one third optical partial element and one fourth optical partial element in a way that the third and the fourth optical partial elements exhibit parts of the at least one optical surface of the second optical element. Moreover, the method comprises mounting the third optical partial element and the fourth optical partial element to the frame system, in a way that the optical surface of the third optical partial element and optical surface of the fourth optical partial element are arranged rotationally symmetrically about a common optical axis.

According to an embodiment, it may thereby be provided that the first optical partial element and the third optical partial element are arranged with a distance from each other along the common optical axis.

According to an embodiment the frame system then comprises an actuator, to vary the distance of the first optical partial element from the third optical partial element along the common optical axis.

In another embodiment, the first optical partial element and the third optical partial element are arranged in a common beam path of the stereoscopic optical system.

Thus, the preceding method enables the manufacturing a stereoscopic optical system enabling a changing of the working distance (focusing) for adjustment to an observed object. The changing of the working distance is performed by variation of the distance of the first and the second optical partial elements from the third and fourth optical partial elements along the common optical axis. The construction achieved by the preceding method ensures that the central beams traversing the optical elements automatically always intersect forming a stereoscopic-angle α in an object plane of the stereoscopic optical systems even after changing the working distance and thus after changing of the distance of the first and second optical partial elements from the third and fourth optical partial elements, provided an appropriate choice of the respective optical surfaces of the first and second optical elements has been made.

According to a further embodiment, a method for manufacturing a stereoscopic optical system comprises the following steps: manufacturing a first optical element exhibiting at least one optical surface rotationally symmetric about an axis; manufacturing a second optical element exhibiting at least one optical surface rotationally symmetric about an axis; dividing the first optical element into a first central optical partial element and two peripheral optical partial elements by two straight cuts; dividing the second optical element into a second central optical partial element and two peripheral optical partial elements by two straight cuts; and mounting the first central optical partial element and the second central optical partial element to a frame system, in a way that an optical surface of the first central optical partial element and an optical surface of the second central optical partial element are arranged rotationally symmetrically about one common optical axis, respectively.

By dividing the first and second optical elements into a first and second central optical partial element, respectively, and two peripheral optical partial elements, respectively, wherein solely the first and second central optical partial elements are mounted in a frame system of the stereoscopic optical system, a reduction of the weight of the stereoscopic optical system is achieved in a particularly simple way.

According to an embodiment, it may be envisaged that the first central optical partial element and the second central optical partial element are arranged with a distance from each other along the common optical axis.

According to an embodiment the frame system comprises an actuator, to vary the distance of the first central optical partial element from the second central optical partial element along the common optical axis.

Thus, the preceding method enables the manufacturing a stereoscopic optical system enabling a changing of the working distance (focusing) for the adjustment to an observed object. The changing of the working distance is performed by a variation of the relative distance of the first and second central optical partial elements from each other along the common optical axis. Thereby, the construction achieved by the preceding method ensures that central beams traversing the optical partial elements of a left beam path and a right beam path of the stereoscopic optical system automatically always (that means within a range of application of the stereoscopic system) intersect upon inclusion of a stereoscopic-angle α in an object plane of the stereoscopic optical system, even after changing of the working distance and thus after changing of the preceding relative distance between the first and the second central optical partial elements, provided an appropriate choice of the respective optical surfaces of the first and second optical elements, and thus of the first and second central optical partial elements, has been made.

According to an embodiment, the first and/or the second optical elements may be optical lenses. According to an alternative embodiment, the first and/or second optical element may for example however also be optical mirrors.

According to an embodiment, the stereoscopic optical system is a head-mountable loupe fixable to a head of a user.

According to an alternative embodiment, the stereoscopic optical system may be a stereoscopic microscope, in particular a surgery microscope.

In the following, embodiments of the present invention are described with reference to the accompanying drawings. In the drawings, same or similar elements are denoted with same or similar reference numerals. Hereby, shows

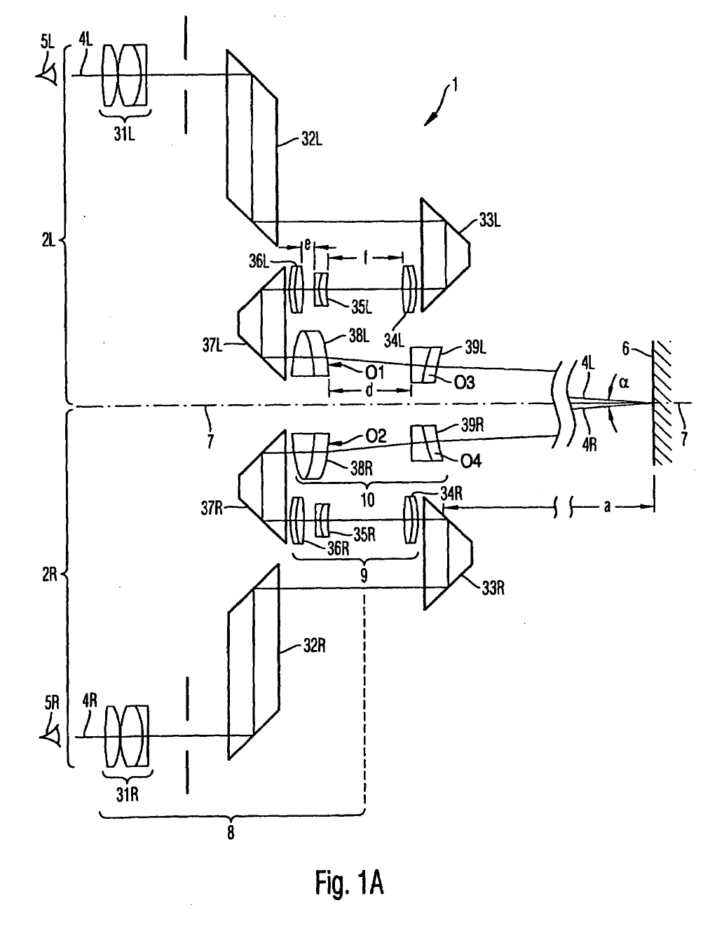

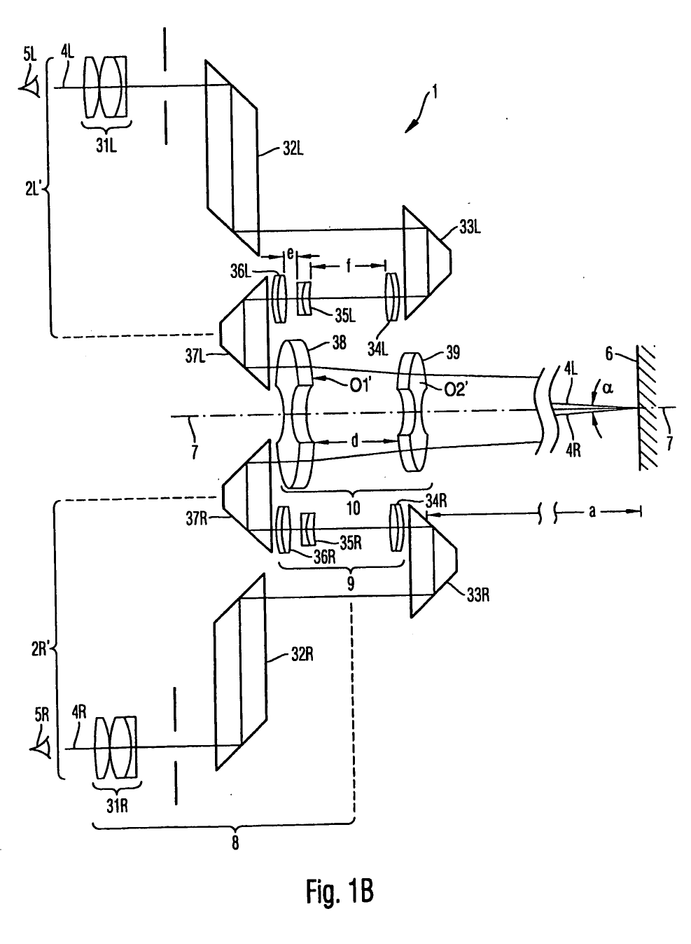

FIG. 1A in schematic illustration a beam path through a stereoscopic system according to a first embodiment of the present invention by using a head-mountable loupe as example;

FIG. 1B in schematic illustration a beam path through a stereoscopic system according to a second embodiment of the present invention by using a surgery microscope as example;

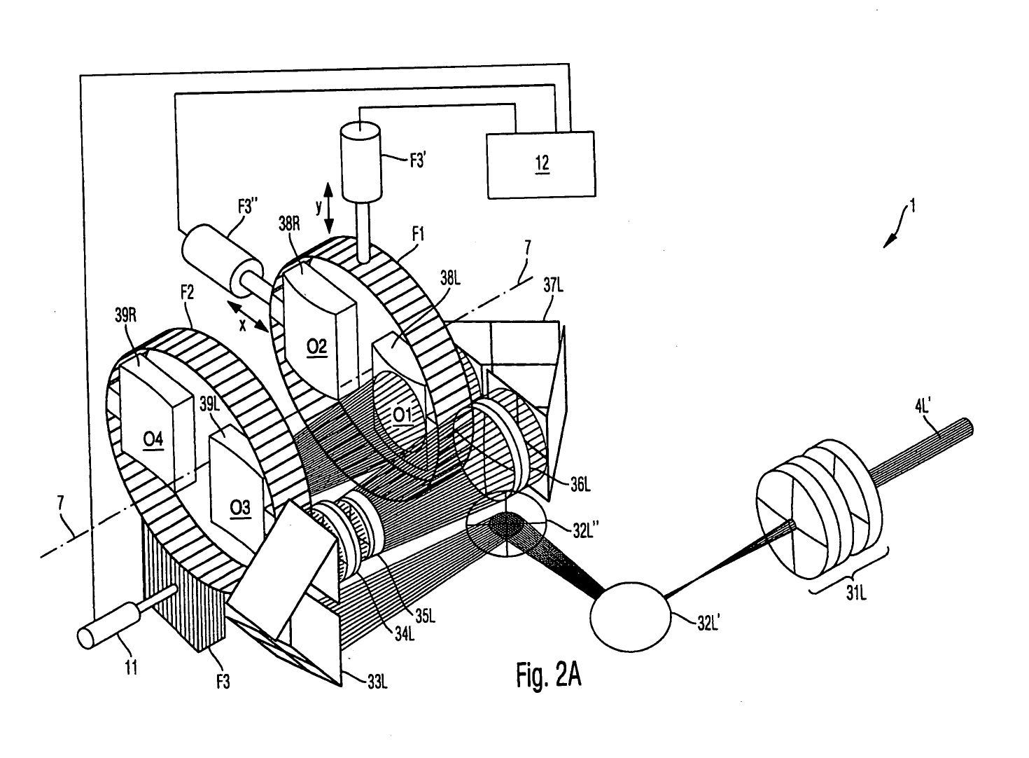

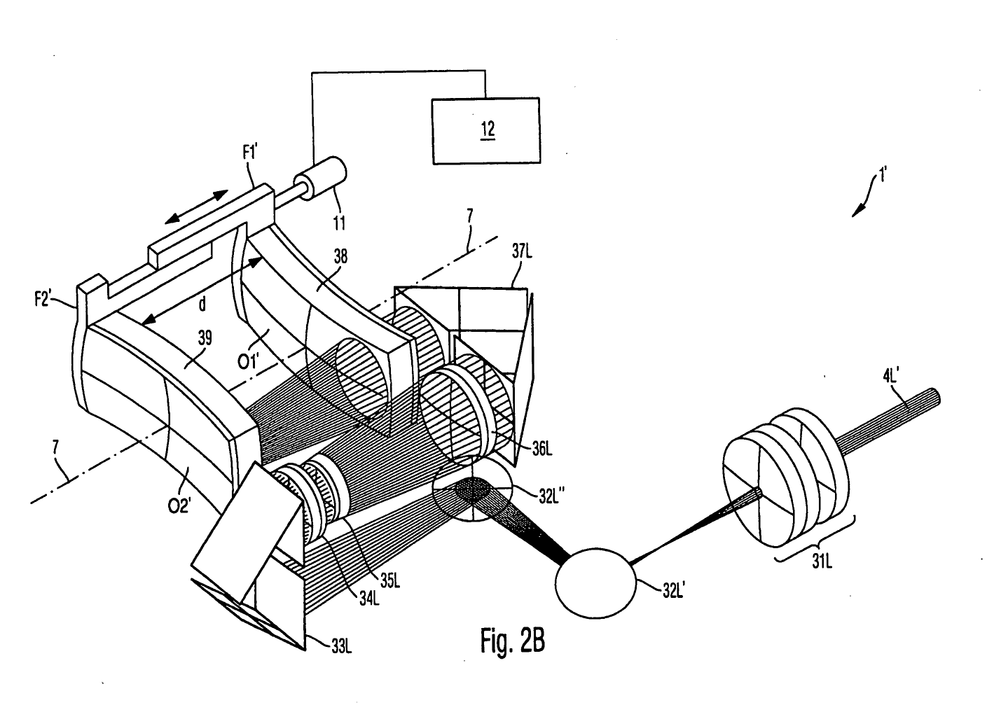

FIG. 2A schematically a spatial illustration of optical components of the head-mountable loupe shown in FIG. 1A, as well as a traversing beam bundle;

FIG. 2B schematically a spatial illustration of optical components and a traversing beam bundle of a sub-system of a stereoscopic optical system according to an alternative embodiment of the present invention;

FIG. 2C schematically a spatial illustration of optical components of the surgery microscope shown in FIG. 1B as well as a traversing beam bundle;

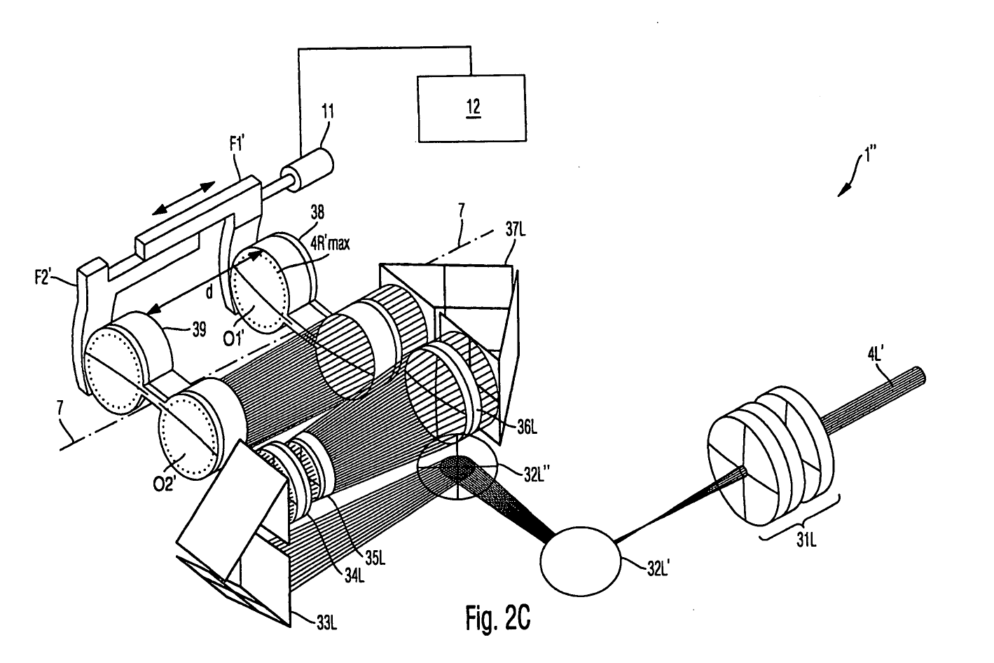

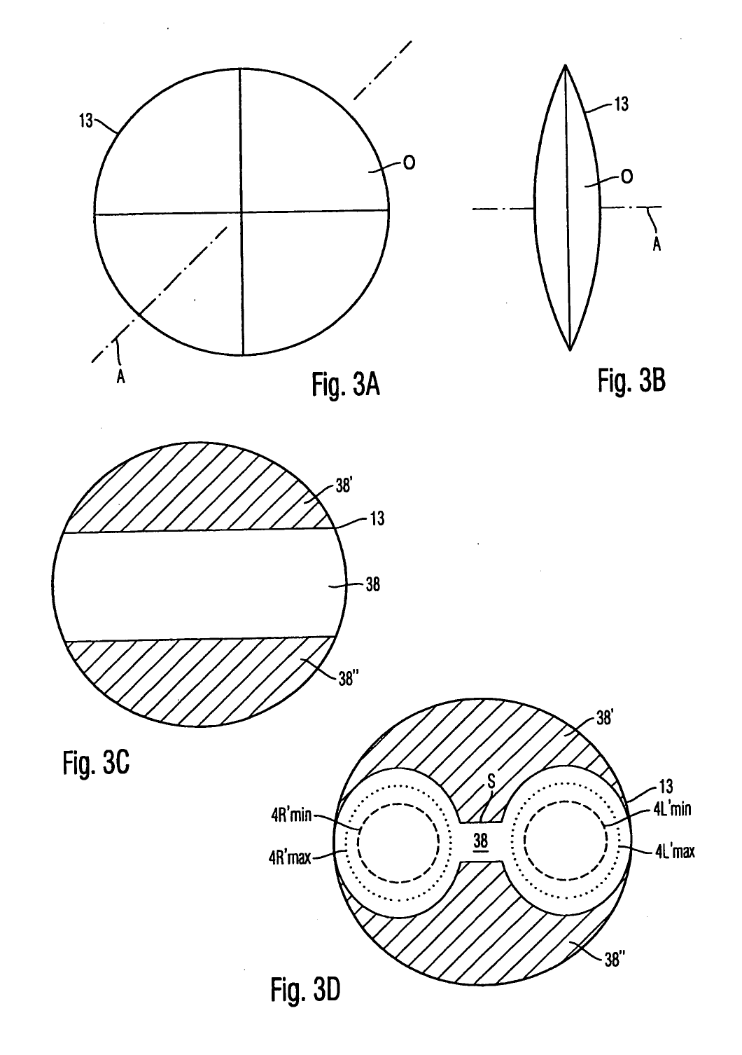

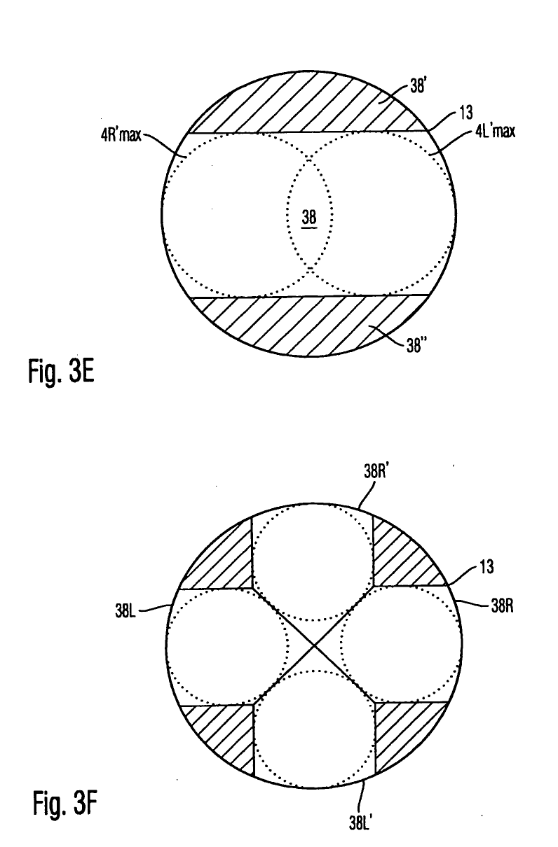

FIG. 3A schematically a front view of a first (respectively second) optical element;

FIG. 3B schematically a side view of the first (respectively second) optical element of FIG. 3A;

FIG. 3C schematically a front view of an optical element according to the alternative embodiment;

FIG. 3D schematically a front view of a first (respectively second) optical element according to the second embodiment;

FIGS. 3E, 3F each schematically a front view of a first (respectively second) optical element according to alternative embodiments;

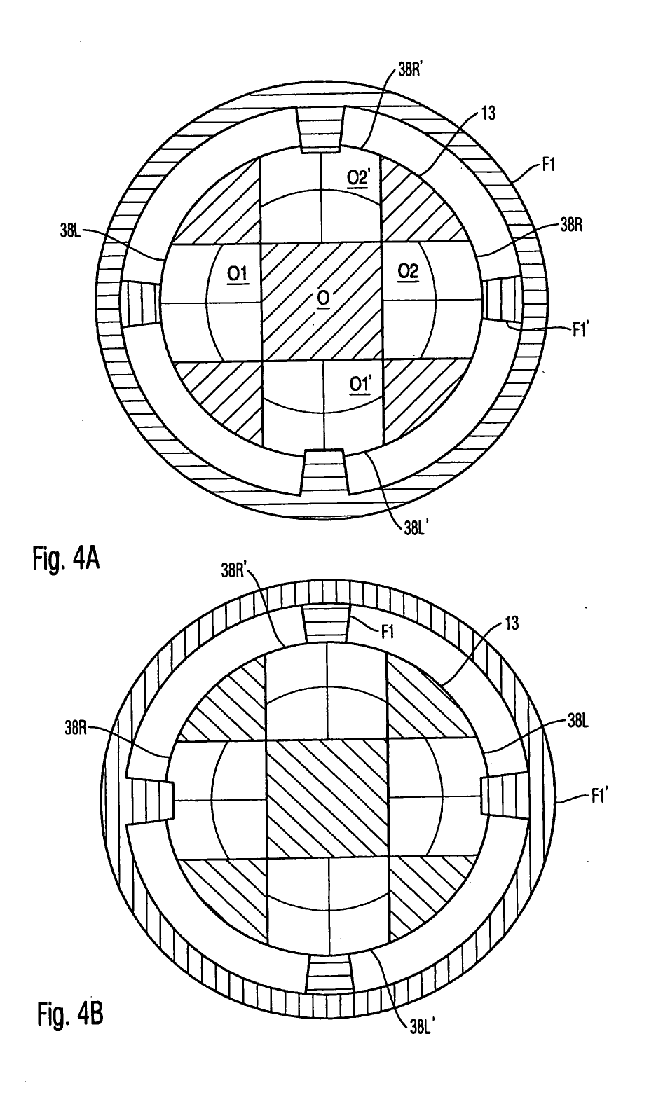

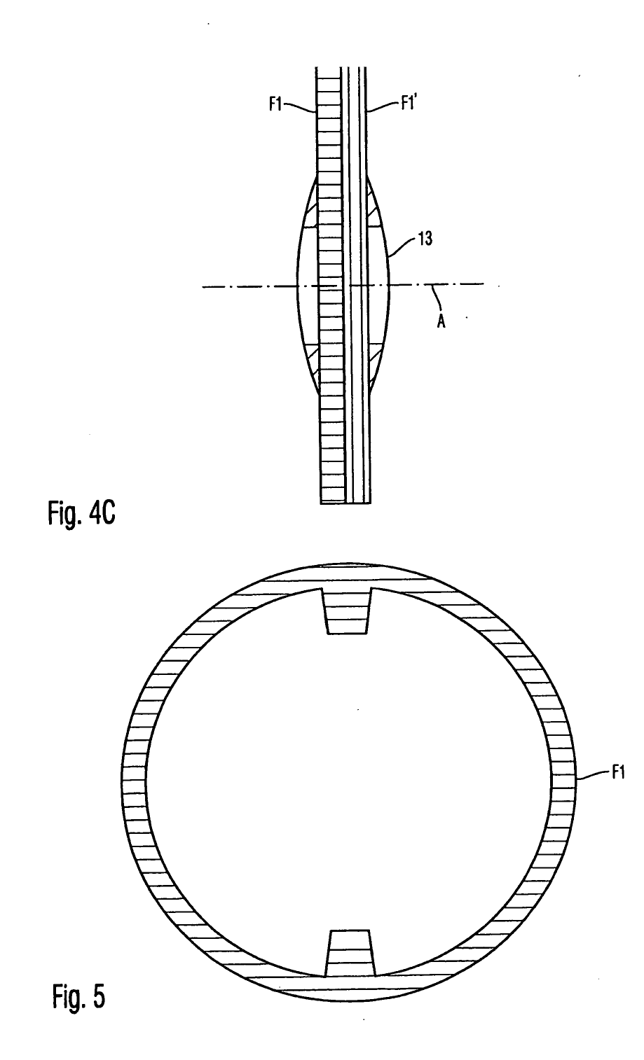

FIG. 4A schematically a front view of a first (respectively second) optical element fixed to two first frame components of two frame systems;

FIG. 4B schematically a rear view of FIG. 4A;

FIG. 4C schematically a side view of FIG. 4A;

FIG. 5 schematically a front view of a first frame component used in FIG. 4A;

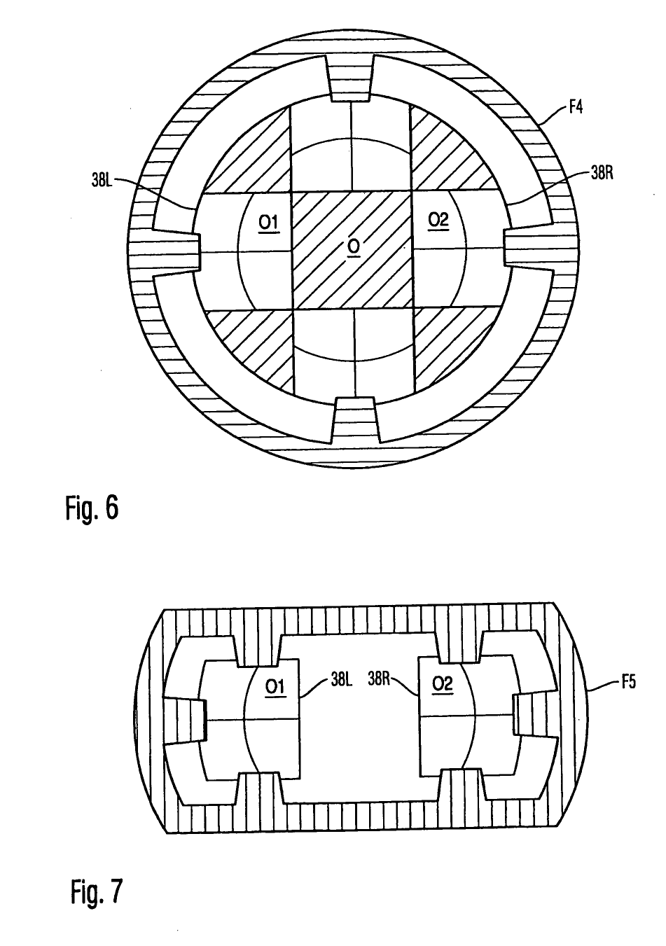

FIG. 6 schematically a front view of a first (respectively second) optical element fixed to an auxiliary frame;

FIG. 7 schematically a front view of a first frame component used in connection to the auxiliary frame shown in FIG. 6;

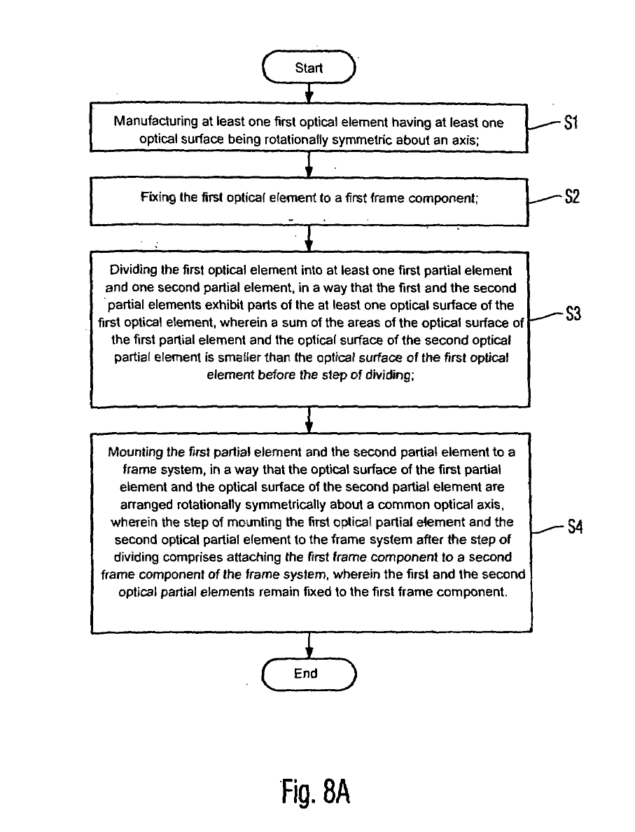

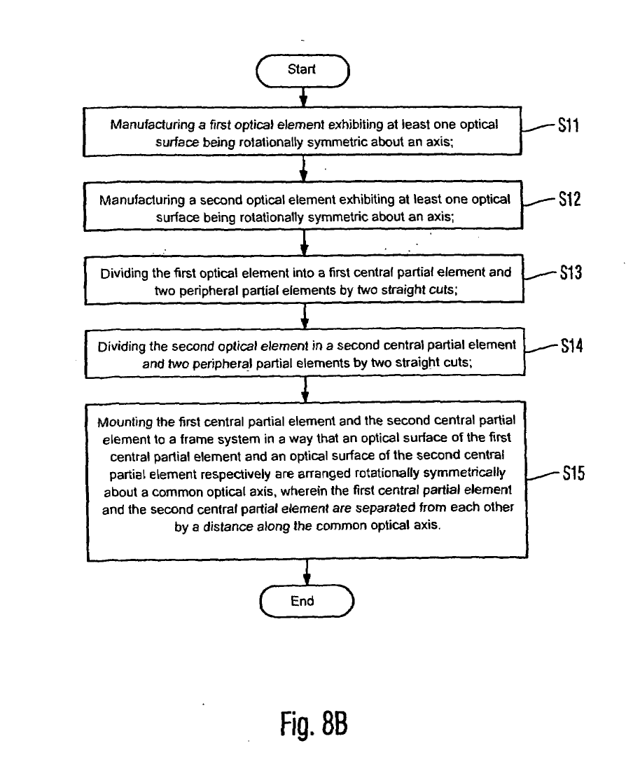

FIG. 8A a flow diagram of a method for manufacturing a stereoscopic optical system according to a first embodiment;

FIG. 8B a flow diagram of a method for manufacturing a stereoscopic optical system according to an alternative embodiment; and

FIG. 9 in schematic illustration a beam path through a stereoscopic system according to the prior art.

In FIG. 1A a beam path through a stereoscopic optical system according to a first embodiment of the present invention is schematically illustrated by using a head-mountable loupe 1 as an example.

The optical system of the head-mountable loupe 1 is constructed symmetrically with respect to a common center axis 7 of the optical system for left (first) and right (second) beam paths 4L and 4R by a left (first) optical sub-system 2L and a right (second) optical sub-system 2R. In FIG. 1A the central beams of the beam bundles traversing them respectively represent the left and right beam paths 4L and 4R.

The head-mountable loupe 1 is fixable to the head of an observer using headbands, such that a left and right eyes 5L and 5R, respectively, of the observer looks into a left and right exit ocular 31L, 31R of the head-mountable loupe 1. FIG. 1A illustrates left and right central beams of partial beam bundles traversing the left and right beam paths 4L and 4R, which are supplied to the eyes 5L, 5R of the observer through the exit oculars 31L, 31R. The central beams are repeatedly folded by mirrors 32L, 33L, 37L, respectively 32R, 33R, 37R, of the head-mountable loupe 1 and imaged by the objective system 10 such that they meet at an object 6 to be observed and such that they thereby intersect forming a stereoscopic-angle α with each other.

The head-mountable loupe 1 thus maps an image of the object 6 on each eye 5L, 5R of the observer, wherein the observing angles of both images differ by the stereoscopic-angle α, such that a stereoscopic spatial impression of the observed object 6 arises for the observer. The magnitude of the stereoscopic-angle α depends of the respective working distance a of the observed object 6 from the objective system 10 of the head-mountable loupe 1. According to an embodiment, the stereoscopic-angle α amounts to between 2° and 10°. According to a further embodiment, the stereoscopic-angle α amounts to between 4° and 6°.

The central beams of the two beam paths 4L, 4R incident from the object 6 enter an objective system 10 of the head-mountable loupe 1, which objective system 10 is formed by two pairs of optical partial lenses 38L, 38R and 39L, 39R.

Thereby, the first optical partial lens 38L exhibits a first optical surface O1, the second optical partial lens 38R exhibits a second optical surface O2, the third optical partial lens 39L exhibits a third optical surface O3 and the fourth optical partial lens 39R exhibits a fourth optical surface O4. Thereby, the first and second optical surfaces O1 and O2, as well as the third and the fourth optical surfaces O3 and O4, are pairwise partial surfaces of one common mathematical surface, respectively, which is rotationally symmetric about the common principal axis 7 of the head-mountable loupe 1. Consequently, these pairs of optical partial lenses 38L, 38R and 39L, 39R, respectively, function as an optical lens common for the left and right central beams of the left and right beam paths 4L and 4R.

According to an embodiment the common mathematical surface is continuous. According to a further embodiment, the common mathematical surface is continuously convex or concave and thus exhibits a curvature of constant sign. According to a further embodiment the common mathematical surface is a sphere.

As apparent from FIG. 1A, the first and second optical surfaces O1, O2 as well as the third and the fourth optical surfaces O3, O4 of the two pairs of optical partial lenses 38L, 38R and 39L, 39R exhibit, respectively, in the sum an area which is smaller than an area O which would evolve, if the two pairs of optical partial lenses 38L, 38R and 39L, 39R, respectively, would each be formed by one common optical lens. Thus, due to the preceding construction a saving of lens material and thus a saving in weight for the head-mountable loupe 1 is achieved.

The first and the third optical partial lenses 38L, 39L as well as the second and the fourth optical partial lenses 38R, 39R are removed from each other along the central axis 7 of the head-mountable loupe 1 by a distance d, respectively. Thereby, the first and the third optical partial elements 38L, 39L as well as the second and the fourth optical partial elements 38R, 39R each are arranged in one common beam path 4L, respectively 4R, of the head-mountable loupe 1.

Via a motor (actuator) 11 illustrated in the FIGS. 2A and 2B this distance d can be adjusted in dependence of a controller 12 of the head-mountable loupe 1.

Focusing is enabled by variation of the distance d along the center axis via the motor 11 adjusting the head-mountable loupe 1 to the respective working distance a of the observed object 6. Thereby, the preceding construction ensures with appropriate choice of each of the mathematical surfaces common for the first and second optical partial lenses 38L, 38R, and for the third and fourth optical partial lens 39L, 39R, respectively, that central beams of the left and right beam path automatically always intersect forming a stereoscopic-angle α in the object plane 6 of the head-mountable loupe 1, even after changing the working distance a and thus after changing the distance d.

Furthermore, by changing of lens distances e and f in the head-mountable loupe 1 an adjustable magnification (zoom function) of the observed object 6 is possible.

As is well apparent from FIG. 1A of this embodiment, the left and right central beams 4L, 4R are exclusively guided from separate left optical elements 31L, 32L, 33L, 34L, 35L, 36L, 37L, 38L, 39L and right optical elements 31R, 32R, 33R, 34R, 35R, 36R, 37R, 38R, 39R, respectively. In the region of an objective system 10 formed by the optical lenses 38L, 38R, 39L, 39R, at least one optical element (not shown) common to the left and right central beams 4L, 4R can, in addition, be provided as an alternative.

After having passed through the objective system 10, the central beams 4L and 4R, respectively, enter an ocular system 8 wherein a particular ocular system 8 is associated separately to each of the two central beams 4L, 4R. Thereby, the objective system 10 maps the beam bundles incident from the object 6 to infinity.

For clarification of the construction of the head-mountable loupe 1, FIG. 2A shows in spatial illustration a partial beam bundle 4L′ entering the left eye 5L of the observer 3, wherein the central beam of the partial beam bundle 4L′ is illustrated in FIG. 1A.

Thereby, FIG. 2A additionally shows two first frame components F1, F2 to which the optical partial lenses 38L, 38R and 39L, 39R, respectively, are fixed. The two first frame components F1, F2 carrying the optical partial lenses 38L, 38R and 39L, 39R, respectively, are carried by second frame components F3, F3′, F3″ of a frame system of the preceding head-mountable loupe 1.

Thereby, in FIG. 2A, the second frame component F3 is displaceable along the central axis 7 of the head-mountable loupe 1 via the motor 11 in dependency on the controller 12. Thereby, the distance d between the first frame component F1 carrying the first and second optical partial lenses 38L, 38R and the first frame component F2 carrying the third and the fourth optical partial lenses 39L, 39R is adjustable. Consequently, a working distance a (see FIG. 1) between the first frame component F2 carrying the third and fourth optical partial lenses 39L, 39R and an object plane is also changeable, wherein in this object plane the imaging of the object 6 is carried out sharply focused onto the eyes 5L, 5R. In the explanatory embodiment described here the distance d is changeable in a range between 18.0 mm and 0.5 mm, leading to a changing of the working distance a in the range from 250 mm to 500 mm.

Furthermore, in FIG. 2A, the first frame component F1 is carried by the second frame components F3′, F3″. The first frame component F1 that carries the first and second optical partial lenses 38L, 38R is displaceable in two directions x, y that are orthogonal to the central axis 7 of the head-mountable loupe 1 via the second frame components F3′, F3″ in dependence on the controller 12. This lateral displacement of the first frame components F1 serves to automatically balance a vibration or a wobbling of the head-mountable loupe 1. For this, the controller 12 is connected to sensors (not illustrated) for vibrations and positional changes, respectively, of the head-mountable loupe 1.

Although the present invention was described above by using a head-mountable loupe 1 as an example, the stereoscopic optical system according to the invention may alternatively also be a stereoscopic microscope, in particular a surgery microscope, for example. Further, it has to be understood that it is possible to deviate from the number of optical elements and number of optical partial lenses shown in FIGS. 1A and 2A. Moreover, the optical elements and optical partial lenses of the stereoscopic system according to the invention may also be compound elements constructed from two or more optical partial lenses with different refractive forces, or the like. Moreover, it is possible that one or several of the optical elements of the stereoscopic optical system are lenses with variable refraction force (for example a fluid lens or a fluid crystal lens (LC-lens)). Instead of using optical lenses, it is possible to use optical mirrors as optical elements or optical partial lenses, respectively.

In the following an embodiment of the method for the manufacturing of the above described head-mountable loupe 1 according to the invention is further described with reference to the FIGS. 1A, 2A, 3A, 3B, 4 to 7 and 8A. It is understood that this method is also suitable for manufacturing a stereoscopic optical system not being a head-mountable loupe, but being a stereoscopic microscope (stereomicroscope), for example.

According to the inventive method, at least one first optical element 13, with at least one optical surface O rotationally symmetric about an axis A, is manufactured in a first step S1. As shown in the FIGS. 3A and 3B, the first optical element 13 may for example be an optical lens formed as a compound element. Alternatively, it may for example also be an optical mirror.

In the subsequent step S2 fixing the first optical element 13 to a first frame component F1 is carried out. An appropriate first frame component F1 is shown in FIG. 5.

In this embodiment, the optical element 13 is concurrently fixed to two frame components F1 and F1′ rotated 90° relative to each other in step S2. This is shown in FIGS. 4A, 4B and 4C. Thereby, FIG. 4A schematically shows a front view of the first optical element 13 fixed to two first frame components F1, F1′ of two frame systems. FIG. 4B schematically shows a rear view of FIG. 4A and FIG. 4C schematically shows a side view of FIG. 4A. Subsequently, a step of dividing S3 the first optical element 13 into at least one first optical partial lens 38L and one second optical partial lens 38R is performed. The step of dividing may be performed e.g. by sawing or cutting. Corresponding to the number of first frame components F1 and F1′ in the FIGS. 4A, 4B and 4C, a dividing in two pairs of first and second optical partial lenses 38L, 38R and 38L′, 38R′ is illustrated. Alternatively, however, dividing into only one pair or a larger number of pairs of optical partial lenses is also possible. Thereby, the diagonally shaded areas of the first optical element 13 in the FIGS. 4A, 4B, 4C indicate optical partial lenses which will be discarded after the dividing.

The dividing is performed such that the pairs of first and second optical partial lenses 38L, 38R and 38L′, 38R′ respectively exhibit parts of the at least one optical surface O of the first optical element 13 after the dividing. Consequently, the sum of the areas of the optical surfaces O1, O2, O3 and O4 is smaller or equal to the optical surface O of the first optical element 13 before the dividing.

According to an alternative embodiment shown in FIG. 3F, the step of dividing the first optical element 13 into the two pairs of first and second optical sub-systems 38L, 38R and 38L′, 38R′ is performed such that only little material of the first optical element 13 is discarded. The material to be discarded is illustrated by shading in FIG. 3F. Thereby, in FIG. 3F maximal values of the respective cross sections of bundles of imaging beams are additionally illustrated with dotted lines, which bundles of imaging beams traverse the pairs of first and second optical partial lenses 38L, 38R and 38L′, 38R′.

After the dividing, the two first frame components F1, F1′ are separated from each other, wherein at each of the first frame components F1 and F1′, a pair of the optical partial lenses 38L and 38R, respectively 38L′ and 38R′, remains fixed. The two first frame components F1, F1′ with the pair of optical partial lenses 38L, 38R, and 38L′, 38R′, respectively, fixed therewith can each then be used for manufacturing a head-mountable loupe 1 according to this invention. This is performed by assembling the respective first frame component F1, F1′ in the respective frame system of the respective head-mountable loupe 1.

Subsequently, the first frame component F1 is attached to a second frame component F3, respectively F3′, F3″, of a frame system of the inventive head-mountable loupe 1 in step S4, wherein the first and the second optical partial lenses 38L, 38R remain fixed to the first frame component F1. Consequently, the first and the second optical partial lenses 38L, 38R are automatically mounted to the frame system in a way that the optical surface O1 of the first optical partial lens 38L and the optical surface O2 of the second optical partial lens 38R are arranged rotationally symmetrically about a common optical axis 7.

Since it is difficult to adapt the first frame components F1, F1′ such that from the first optical element 13 a large number of pairs of first and second optical partial lenses 38L, 38R, 38L′, 38R′ can be formed, in a modification of the embodiment described above, the usage of an auxiliary frame F4 for the dividing step is also possible.

According to this modified embodiment, fixing the first optical element 13 is not carried out to one or several first frame components F1, F1′ before the step of dividing, but fixing to the auxiliary frame F4. This is shown in FIG. 6.

After the step of dividing and before the step of mounting S4 the first and second optical partial lenses 38L, 38R to the frame system, according to this modified embodiment a step of fixing the first and the second optical partial lenses 38L, 38R to the first frame component F1, F5 is performed. Since the first frame component F1, F5 does not have to enable a fixing and a dividing the first optical element 13 in this embodiment, the first frame component F1, F5 can entirely be adapted to the pair of first and second optical partial lenses 38L, 38R. This is shown in FIG. 7 exemplary using the first frame component F5. At most, the first frame component can also simply be formed by a bar (not especially shown) connecting the first and the optical partial lenses 38L, 38R and thus defining the position and orientation of the first and the second optical partial lenses 38L, 38R relative to each other.

To ensure that the relative position and orientation of the pairs of first and second optical partial lenses 38L, 38R is not impaired by the movement, the first and the second optical partial lenses 38L, 38R preferably remain fixed to the auxiliary frame F4 during the step of fixing the first and the second optical partial lenses 38L, 38R to the first frame component F1, F1′. Detaching the first and the second optical partial lenses 38L, 38R from the auxiliary frame F4 is only carried out subsequently.

In accordance with the embodiment described above, the step of mounting the first and second optical partial lenses 38L, 38R to the frame system is performed even in the present embodiment by attaching the first frame component F1, F5, respectively, to the second frame component F3, F3′, F3″, respectively, of the frame system, wherein the first and the second optical partial lenses 38L, 38R remain fixed to the first frame component F1, F5, respectively.

For manufacturing the head-mountable loupe 1 shown in FIG. 1A, it is in general advantageous that the method further comprises manufacturing a second optical element exhibiting at least one optical surface rotationally symmetric about an axis. Since this second optical element differs from the first optical element 13 only in the choice of the optical surface rotationally symmetric about the axis, it is not especially illustrated in the Figures.

Further, the method preferably further comprises a step of dividing the second optical element into at least one third optical partial lens 39L and one fourth optical partial lens 39R in a way that the third and the fourth optical partial lenses 39L, 39R exhibit parts of the at least one optical surface of the second optical element. Subsequently, the third optical partial lens 39L and the fourth optical partial lens 39R are mounted to the frame system in a way that the optical surface O3 of the third optical partial lens 39L and the optical surface O4 of the fourth optical partial lens 39R are arranged rotationally symmetrically about the common optical axis 7 of the head-mountable loupe 1. Thereby, the first optical partial lens 38L and the third optical partial lens 39L are preferably arranged in a common central beam 4L of the head-mountable loupe 1 removed from each other along the common optical axis 7 by distance d, as shown in FIG. 1A.

Consequently, the inventive method described above enables the manufacture of the inventive head-mountable loupe 1 with simplicity and in a cost effective way with the required accuracy. Moreover, the method enables a reduction of the structural shape of the objective system 10 of the head-mountable loupe 1 and thus a reduction of the weight of the stereoscopic optical system.

Concurrently, the construction achieved by the inventive method ensures (provided appropriate choice of the respective optical surfaces O of the first and the second optical elements 13, and thus the optical surfaces O1, O2, O3, O4 of the optical partial lenses 38L, 38R, 39L, 39R is made) that central beams of the two beam paths 4L, 4R automatically always intersect in an object plane 6 of the head-mountable loupe 1 forming a stereoscopic-angle α, even after a change of the working distance and thus after a change of the distance d between the respective first and third and second and fourth optical partial lenses 38L, 39L, and 38R, 39R, respectively.

In the following, an alternative embodiment of the inventive method for manufacturing an alternative head-mountable loupe 1′ is described with reference to FIGS. 2B, 3A, 3B, 3C and 8B. Except for the design of the optical elements of the objective system 10, the head-mountable loupe 1′ exhibits the construction shown in FIG. 1A. The description of identical elements is therefore not made in the following.

According to this embodiment the method for manufacturing the head-mountable loupe 1′ has the following steps:

Initially, in step S11, a first optical element 13 exhibiting at least one optical surface O rotationally symmetric about an axis A is manufactured.

According to an embodiment, the rotationally symmetric optical surface O of the first optical element 13 is continuous and exhibits the shape of a sphere.

Subsequently or concurrently, in step S12, a second optical element is manufactured exhibiting also at least one optical surface rotationally symmetric about an axis.

According to an embodiment, also the rotationally symmetric optical surface of the second optical element is continuous and exhibits the shape of a sphere. Thereby, the rotationally symmetric optical surfaces of the first and the second optical elements may be alike or different.

In the embodiment described here, the first and the second optical elements 13 are optical lenses. Alternatively, they may also be optical mirrors, for example. A corresponding first and second optical element 13 is shown in the FIGS. 3A and 3B.

In the following step S13 a dividing the first optical element 13 in a first central optical partial lens 38 and two peripheral optical partial lenses 38′, 38″ is performed by two straight cuts. Subsequently or concurrently, a dividing S14 the second optical element in a second central optical partial lens 39 and two peripheral optical partial lenses by two straight cuts is performed. This is schematically illustrated in FIG. 3C. Thereby, the diagonally shaded areas indicate the peripheral optical partial lenses 38′, 38″.

After the step of dividing, the first central optical partial lens 38 and the second central optical partial lens 39 are mounted in step S15 to a frame system, in a way that an optical surface O1′ of the first central optical partial lens 38 and an optical surface O2′ of the second central optical partial lens 39 are respectively arranged rotationally symmetrically about a common optical axis 7 of the head-mountable loupe 1′. This assembling is performed by using a pair of first frame components F1′ and F2′, respectively, to which the first and second central optical partial lens 38 and 39, respectively, is fixed. Thereby, the first central optical partial lens 38 and the second central optical partial lens 39 are preferably separated from each other by a distance d along the common optical axis 7. The first frame components F1′, F2′ thereby allow a variation of the distance d along the common optical axis by using a motor 11.

In the embodiment shown in FIG. 2B, the peripheral optical partial lenses 38′ and 38″ are discarded. Alternatively, it is however also possible to abolish the central optical partial lenses 38, 39 and to mount the peripheral optical partial lenses 38′, 38″ in the head-mountable loupe in a way such that an optical surface of a first peripheral optical partial lens and an optical surface of a second peripheral partial lens are respectively arranged rotationally symmetrically about one common optical axis of the stereoscopic optical system.

According to an alternative embodiment shown in FIG. 3E, the first optical element 13 is used as first central optical partial lens 38 to an especially large extent. As a consequence, a small amount of material (the peripheral optical partial lenses 38′, 38″) must be discarded. In this embodiment, the extended utilization of the first optical element 13 is promoted in that maximal values of the respective cross sections of the bundles of imaging beams 4L′max, 4R′max partly overlap on the optical surface of the first central optical partial lens 38. These maximal values of the cross sections are illustrated in FIG. 3E as dotted lines.

Only the left optical sub-system of the head-mountable loupe 1′ is completely illustrated in FIG. 2B. For the person skilled in the art, it is, however, known (see FIG. 9) that a stereoscopic optical system for left and right central beams 4L and 4R is regularly constructed symmetrically with respect to the common central axis 7 of the optical system from a left and a right (in FIG. 2B not completely shown) optical sub-system 2L, 2R.

By dividing the first and the second optical elements 13 into a first, respectively second, central optical partial lens 38, 39 and respectively a pair of peripheral optical partial lenses 38′, 38″, wherein merely the first and the second central optical partial lenses 38, 39 are mounted in the frame system of the head-mountable loupe 1′, a reduction of the weight of the head-mountable loupe 1′ is achieved in a especially simple way. Moreover, the method enables a diminishment of the structural shape of the head-mountable loupe.

Concurrently, the construction achieved by the inventive method ensures (provided appropriate choice of the respective optical surfaces O1′, O2′ of the first and the second optical elements 13 and thus the first and the second central optical partial lenses 38, 39 is made) that central beams of the left and the right beam paths 4L, 4R automatically always (that means across the entire adjustment range of the head-mountable loupe) intersect forming a stereoscopic-angle α in an object plane 6 of the head-mountable loupe 1, even after a change of the relative distance between the first and the second central optical partial lenses 38, 39.

It is also evident that this alternative embodiment is not restricted to head-mountable loupes. Rather, the stereoscopic optical system may also be a stereoscopic microscope, for example.

In the following, the construction of a stereoscopic system according to a second embodiment of the present invention is described with reference to FIGS. 1B, 2C, 3A, 3B and 3D, using a surgery microscope 1″ as an example. Except the design of the optical elements of the objective system 10, the surgery microscope 1″ exhibits a construction corresponding to the construction of the head-mountable loupe 1 shown in FIG. 1A. Therefore, identical elements are not described in the following.

As shown in FIGS. 1B and 2C, the surgery microscope 1″ serves to display a stereoscopic image of an object 6 via a left beam path 4L and a right beam path 4R. In FIG. 1B the left and the right beam paths 4L and 4R are respectively symbolized by central beams traversing them. In FIG. 2C the left beam path 4L is symbolized by the bundle of imaging beams 4L′ traversing it.

The surgery microscope 1″ shown here comprises a principal optics 10 having a first optical lens 38 and a second optical lens 39. The principal optics is commonly traversed by the left beam path 4L and the right beam path 4R. Thereby, the first and the second optical lenses 38, 39 are arranged in a way that they exhibit a common optical principal axis 7 and are separated from each other by a distance d along the common optical principal axis 7.

The principal optics 10 corresponds to the objective of the preceding embodiments.

Moreover, the surgery microscope 1″ exhibits a left optical sub-system 2L′ having a plurality of optical elements 31L, 32L, 33L, 34L, 35L, 36L, 37L merely traversed by the left beam path 4L and a right optical sub-system 2R′ having a plurality of optical elements 31R, 32R, 33R, 34R, 35R, 36R, 37R merely traversed by the right beam path 4R.

The optical elements 31L, 32L, 33L, 34L, 35L, 36L, 37L, 31R, 32R, 33R, 34R, 35R, 36R, 37R and the first and second optical lenses 38, 39 may be, for example, simple lenses or compound elements constructed from two optical partial lenses with different refractive forces or the like. Furthermore, it is possible that one or several of the optical elements of the stereoscopic optical system are lenses of variable refraction force (for example a fluid lens or a fluid crystal lens (LC-lens)). Lenses of variable refraction force are normally not moved relative to other lenses for variation of their refraction force, but are correspondingly controlled. Instead of the usage of optical lenses, the use of optical mirrors is also possible. It is understood that deviation from the number of optical elements and first and second optical lenses shown in FIGS. 1B and 2C is possible.

As indicated in FIG. 1B by the distances d, e and f, at least one optical lens 38, 39 of the principal optics 10 and one optical element 34L, 35L, 36L, 34R, 35R, 36R of the left and the right optical sub-systems 2L′, 2R′ are displaceable relative to each other. Thereby, a refraction force of an optical group formed by the at least one optical lens 38, 39 of the principal optics 10 and the at least one optical element 34L, 35L, 36L, 34R, 35R, 36R of the left and the right optical sub-systems 2L′, 2R′ is variable in a way that cross sections of an bundle of imaging beams 4L′ of the left beam path 4L and a bundle of imaging beams 4R′ of the right beam path 4R change in dependency on the variation of the refraction force of the group, and thus in dependency on the displacement. In the illustrated embodiment, an adjustable magnification (zoom function) of the observed object 6 is possible by changing of the distances e and f, and an adjustment of the surgery microscope 1″ to the respective working distance a of the observed object 6, and thus focusing is possible by changing the distance d. To change the relative distance d of the first optical lens 38 from the second optical lens 39 along the optical principal axis 7, an actuator in the form of a motor 11 is provided in this embodiment.

As an alternative to the relative displacement of at least one optical element 38, 39 of the principal optics 10 and at least one optical element 34L, 35L, 36L, 34R, 35R, 36R of the left and the right optical sub-system 2L′, 2R′ described above, the usage of at least one optical element of variable refraction force is also possible to vary the refractive power of the group thus formed.

The at least one optical element of variable refraction force may be a liquid crystal lens or a fluid lens, for example, which may replace the optical elements 35L, respectively 35R, in FIG. 1B, for example.

A refraction force of this optical element of variable refraction force is variable by controlling the optical element in a way that cross sections of a bundle of imaging beams 4L′ of the left beam path 4L and of a bundle of imaging beams 4R′ of the right beam path 4R change in dependency on the variation of the refraction force and thus on the controlling.

As shown in the FIGS. 1B, 2C and 3D, an outer shape of the first and the second optical lenses 38, 39 of the principal optics 10 is chosen in a way that a respective total area of the optical surface O1′, O2′ of the first and second optical lenses 38, 39, respectively, exhibits a value which is smaller than 1.8-times a maximal value of the area covered by the respective cross sections of the bundles of imaging beams 4L′max, 4R′max on the respective optical surfaces O1′, O2′ of the first and second optical lenses 38, 39 of the principal optics 10.

This is clarified in FIG. 3D. FIG. 3D schematically shows a front view of an optical lens 13 suited for the manufacturing of the first, respectively, second, optical lens 38, 39. FIG. 3B shows a side view of the optical lens 13.

The first and second optical lens 38, 39 respectively, are preferably formed by separating from the optical lens 13, as shown in FIG. 3D. This may for example be performed by sawing or cutting. Alternatively, it is also possible, to form the first and second optical lens 38, 39 by ablating material of the optical lens 13 (for example by grinding, planing, milling). The diagonally shaded area shows partial lenses 38′, 38″ (respectively regions) of the optical lens 13 which will be discarded. Further, in FIG. 3D maximal values 4L′max, 4R′max and minimal values 4L′min, 4R′min of the areas covered by the respective cross sections of the bundles of imaging beams 4L′, 4R′ on the optical surface O1 of the first optical lens 38 of the principal optics 10 are shown with dotted lines and dashed lines, respectively. The maximal value of the area covered by the respective cross sections of the bundles of imaging beams 4L′max, 4R′max depends on the distances d, e and f and on the arrangement of the respective optical surfaces O1′, O2′ in this embodiment and may for example be determined experimentally or by calculation.

According to an embodiment, a possible displacement of the bundles of imaging beams 4L′, 4R′ on the optical surface of the respective lens of the principal optics 10 following a changing of the working distance and/or the imaging magnification are also considered when determining the maximal value of the area covered by the respective cross sections of the bundles of imaging beams 4L′max, 4R′max.

It is apparent that the design shape of the first optical lens 38 in FIG. 3D is adapted to the maximal value of the area covered by the respective cross sections of the bundles of imaging beams 4L′max, 4R′max. Between the two regions of the first optical lens 38 guiding the bundles of imaging beams 4L′, 4R′, a bar S is provided in the embodiment shown in FIG. 3D. Due to the bar S the two regions guiding the bundles of imaging beams 4L′, 4R′ are defined with respect to their relative position and orientation. Moreover, the bar S may optionally be used for mounting the first optical lens 38.

Preferably, the total area of a respective optical surface O1′, O2′ of the first and second optical lens 38, 39, respectively, of the principal optics 10 may exhibit a value which is smaller than 1.5-times, preferably smaller than 1.3-times, preferably smaller than 1.2-times and particularly preferably smaller than 1.1-times of a maximal value of the area covered by the cross sections of the bundles of imaging beams 4L′max, 4R′max on the respective optical surface O1′, O2′ of the first and second optical lens 38, 39, respectively. Thereby, a minimal size and a minimal weight of the first and second optical lens 38, 39, respectively, with respect to the bundles of imaging beams can be achieved.

Instead of optical lenses, optical mirrors can also form the first and/or second optical lens 38 and/or 39, for example. Moreover, the stereoscopic construction described above can, instead of for a surgery microscope, also be used for example for a head-mountable loupe or the like.

1. A stereoscopic optical system comprising:
a first optical sub-system with a plurality of optical elements for providing a left beam path of the stereoscopic optical system, and a second optical sub-system with a plurality of optical elements for providing a right beam path of the stereoscopic optical system;
wherein at least one first optical partial element of the first optical sub-system exhibits a first optical surface, and wherein at least one second optical partial element of the second optical sub-system exhibits a second optical surface; and
wherein the first optical surface and the second optical surface are partial surfaces of one common mathematical surface which is rotationally symmetric about a common principal axis of the stereoscopic optical system.

2. The stereoscopic optical system according to claim 1, wherein
a third optical partial element of the first optical sub-system exhibits a third optical surface, and a fourth optical partial element of the second optical sub-system exhibits a fourth optical surface;
wherein the third and the fourth optical surfaces are partial surfaces of one common mathematical surface which is rotationally symmetric about the principal axis of the stereoscopic optical system; and
wherein the first optical partial element and the third optical partial element exhibit a distance from each other along the principal axis of the stereoscopic optical system.

3. The stereoscopic optical system according to claim 2, further comprising an actuator, to vary the distance of the first optical partial element from the third optical partial element along the principal axis of the stereoscopic optical system.

4. The stereoscopic optical system according to claim 3, wherein the first optical partial element and the third optical partial element are arranged in a common beam path of the stereoscopic optical system.

5. The stereoscopic optical system according to claim 2, wherein the first and the second optical partial elements as well as the third and the fourth optical partial elements are optical lenses.

6. A stereoscopic optical system for displaying a stereoscopic image of an object via a left beam path and a right beam path, wherein the stereoscopic optical system comprises:
principal optics commonly traversed by the left beam path and the right beam path, wherein the principal optics has a first optical element which exhibits an optical principal axis;
a left optical sub-system with a plurality of optical elements merely traversed by the left beam path; and
a right optical sub-system with a plurality of optical elements merely traversed by the right beam path;
wherein a refraction force of at least one of an optical element and an optical group formed by several optical elements is variable such that cross sections of the bundle of imaging beams of the left beam path and of the bundle of imaging beams of the right beam path vary in dependence upon the variation of the refraction force;
wherein the total area of one optical surface of the first optical element of the principal optics exhibits a value which is smaller than 1.8 times a maximum value of the area covered by cross sections of the bundles of imaging beams on the optical surface of the first optical element of the principal optics.

7. The stereoscopic optical system according to claim 6, wherein the at least one optical element is an optical element with variable refraction force and wherein the refraction force of the at least one optical element is variable by controlling the optical element.

8. The stereoscopic optical system according to claim 6,
wherein the optical group is formed by at least one optical element of the principal optics and at least one optical element of the left and the right optical sub-systems; and
wherein at least one of the at least one optical element of the principal optics and the at least one optical element of the left and the right optical sub-systems are displaceable relative to each other for varying the refraction force of the group.

9. The stereoscopic optical system according to claim 6, wherein the total area of an optical surface of the first optical element of the principal optics exhibits a value which is smaller a maximal value of the area covered by the cross sections of the bundles of imaging beams on the optical surface of the first optical element of the principal optics.

10. The stereoscopic optical system according to claim 6, wherein
the principal optics exhibits at least one second optical element which is arranged such that the first and the second optical elements exhibit one common optical principal axis; and
the first optical element and the second optical element exhibit a distance from each other along the common optical principal axis.

11. The stereoscopic optical system according to claim 10, further comprising an actuator to vary the relative distance of the first optical element from the second optical element along the optical principal axis.

12. The stereoscopic optical systems according to claim 10, wherein the first and the second optical elements are optical lenses.

13. The stereoscopic optical system according to claim 1, wherein the stereoscopic optical system is a head-mountable loupe fixable at a head of a user.

14. The stereoscopic optical system according to claim 1, wherein the stereoscopic optical system is a stereoscopic surgical microscope.

15. A method for manufacturing a stereoscopic optical system, the method comprising:
manufacturing at least one first optical element which exhibits at least one optical surface rotationally symmetric about an axis;
dividing the first optical element into at least one first optical partial element and one second optical partial element such that the first and the second optical partial elements exhibit parts of the at least one optical surface of the first optical element; and
mounting the first optical partial element and the second optical partial element at a frame system such that the optical surface of the first optical partial element and the optical surface of the second optical partial element are arranged rotationally symmetrically about one common optical axis.

16. The method according to claim 15, wherein the sum of the areas of the optical surface of the first optical partial element and the optical surface of the second optical partial element is smaller than the optical surface of the first optical element before the dividing.

17. The method according to claim 15, wherein the frame system exhibits a first frame component and a second frame component, and wherein the method further comprises:
fixing the first optical element at the first frame component before the step of dividing;
wherein the step of mounting the first optical sub-system and the second optical sub-system at the frame system after the step of dividing comprises attaching the first frame component to the second frame component, wherein the first and the second optical partial elements remain fixed at the first frame component.

18. The method according to claim 15, wherein the frame system exhibits a first frame component and a second frame component, and wherein the method further comprises:
fixing the first optical element at an auxiliary frame before the step of dividing;
fixing the first optical partial element and the second optical partial element to the first frame component after the step of dividing, wherein the first optical partial element and the second optical partial element remain fixed to the auxiliary frame; and
detaching the first optical partial element and the second optical partial element from the auxiliary frame after the step of fixing the first optical partial element and the second optical partial element to the first frame component;
wherein the step of mounting the first optical partial element and the second optical partial element at the frame system after the step of dividing comprises attaching the first frame component to the second frame component, wherein the first and the second optical partial elements remain fixed to the first frame component.

19. The method according to claim 15,
wherein the step of dividing the first optical element comprises a dividing in a plurality of pairs of optical partial elements; and
wherein the step of mounting comprises a mounting each pair of optical partial elements to a respective separate frame system, to manufacture a plurality of stereoscopic optical systems.

20. The method according to claim 19, wherein each of the frame systems of the plurality of frame systems exhibits a first frame component, and wherein the method further comprises:
fixing the first frame component of each frame system of the plurality of frame systems to the first optical element before the step of dividing; and
separating the first frame components of the plurality of frame systems from each other, wherein on each of the first frame components a pair of the optical partial elements remains fixed, respectively.

21. The method according to claim 15, wherein the method further comprises:
manufacturing a second optical element which exhibits at least one optical surface that is rotationally symmetric about an axis;
dividing the second optical element in at least one third optical partial element and one fourth optical partial element such that the third and the fourth optical partial elements exhibit parts of the at least one optical surface of the second optical element; and
mounting the third optical partial element and the fourth optical partial element to the frame system such that the optical surface of the third optical partial element and the optical surface of the fourth optical partial element are arranged rotationally symmetrically about the common optical axis.

22. The method according to claim 21, wherein the first optical partial element and the third optical partial element are separated by a distance from each other along the common optical axis.

23. The method according to claim 22, wherein the frame system comprises an actuator to vary the distance of the first optical partial element from the third optical partial element along the common optical axis.

24. The method according to claim 21, wherein the first optical partial element and the third optical partial element are arranged along one common beam path of the stereoscopic optical system.

25. A method for manufacturing a stereoscopic optical system, the method comprising:
manufacturing a first optical element which exhibits at least one optical surface being rotationally symmetric about an axis;
manufacturing a second optical element which exhibits at least one optical surface being rotationally symmetric about an axis;
dividing the first optical element into a first central partial element and two peripheral partial elements by two straight cuts;
dividing the second optical element into a second central partial element and two peripheral partial elements by two straight cuts; and
mounting the first central partial element and the second central partial element at a frame system such that an optical surface of the first central partial element and an optical surface of the second central partial element are respectively arranged rotationally symmetric about one common optical axis.

26. The method according to claim 25, wherein the first central partial element and the second central partial element are separated by a distance from each other along the common optical axis.

27. The method according to claim 26, wherein the frame system comprises an actuator to vary the distance of the first central partial element from the second central partial element along the common optical axis.

28. The method according to claim 21, wherein at least one of the first and the second optical elements is a lens.

29. The method according to claim 15, wherein the stereoscopic optical system is a head-mountable loupe fixable to a head of a user.

30. The method according to claim 15, wherein the stereoscopic optical system is a stereoscopic surgical microscope.

31. The stereoscopic optical system according to claim 1, wherein the at least one first optical partial element of the first sub-system is separate from the at least one second optical partial element of the second sub-system.
